(19) United States
(12) Patent Application Publication
(10) Pub. No.: US 2024/0106118 A1
(43) Pub. Date: Mar. 28, 2024

(54) RADIATING ASSEMBLY, RADIATING UNIT, ANTENNA, ANTENNA MAST AND BASE STATION

(71) Applicant: RFS Technologies, Inc., Meriden, CT (US)

(72) Inventor: Wenmin Yang, Shanghai (CN)

(73) Assignee: RFS Technologies, Inc., Meriden, CT (US)

(21) Appl. No.: 18/494,713

(22) Filed: Oct. 25, 2023

Related U.S. Application Data
(63) Continuation of application No. PCT/CN2021/091677, filed on Apr. 30, 2021.

(51) Int. Cl. H01Q 5/307; H01Q 9/34

(52) U.S. Cl. CPC H01Q 5/307; H01Q 9/34

(57) ABSTRACT

Example embodiments of the present disclosure relate to a radiating assembly, a radiating unit, an antenna, an antenna mast and a base station and an antenna. The radiating assembly comprising a first conductive member provided on a first layer and configured to radiate electromagnetic power in a radiating direction; a second conductive member provided on a second layer, the second layer spaced apart from the first layer in a first direction perpendicular to the radiating direction; and a connecting component configured to galvanically connected to the first conductive member and the second conductive member, wherein the first conductive member and the second conductive member are at least partially overlapped when being viewed along the first direction. According to example embodiments of the present disclosure, a dual frequency bands can be obtained with a compact size.

### FIELD

Example embodiments of the present disclosure generally relate to the field of wireless communication, and in particular, to a radiating assembly for use in a radiating unit, a radiating unit, an antenna, an antenna mast and a base station.

### BACKGROUND

In the field of wireless communication, antennas operating at different frequency bands may be integrated into a multi-band antenna. Such a multi-band antenna operates in a wide range of frequency bands. The multi-band antenna with a compact size is strongly required in 4G or 5G communication networks and future generation communication networks. How to provide an antenna having multiple frequency bands, a compact size and a lower cost in a straightforward manner remains a challenge.

### SUMMARY

In general, example embodiments of the present disclosure propose a solution for generating multiple frequency bands and reducing the size of the antenna.

In a first aspect, there is provided a radiating assembly for use in a radiating unit. The radiating assembly comprising a first conductive member provided on a first layer and configured to radiate electromagnetic power in a radiating direction; a second conductive member provided on a second layer, the second layer spaced apart from the first layer in a first direction perpendicular to the radiating direction; and a connecting component configured to galvanically connected to the first conductive member and the second conductive member, wherein the first conductive member and the second conductive member are at least partially overlapped when being viewed along the first direction.

In a second aspect, there is provided a radiating unit. The radiating unit comprising: a radiating assembly of the first aspect, a feeding element configured to support the radiating assembly and electrically coupled to the first conductive member; and a base element configured to support the feeding element and provide ground for the radiating assembly via the feeding element.

In a third aspect, there is provided an antenna. The antenna comprises a radiating assembly according to the first aspect and/or a radiating unit according to the second aspect.

In a fourth aspect, there is provided an antenna mast. The antenna mast comprises a radiating assembly according to the first aspect and/or a radiating unit according to the second aspect.

In a fifth aspect, there is provided a base station. The base station comprises an antenna according to the third aspect and/or an antenna mast according to the fourth aspect.

### BRIEF DESCRIPTION OF THE DRAWINGS

Through the following detailed description with reference to the accompanying drawings, the above and other objectives, features and advantages of the example embodiments disclosed herein will become more comprehensible. In the drawings, several example embodiments disclosed herein will be illustrated in an exemplary and in a non-limiting manner, wherein:

FIG. 1 illustrates an exemplary perspective view of a radiating unit in accordance with an example embodiment of the present disclosure;

FIG. 2 illustrates an exemplary front view of the radiating unit of FIG. 1;

FIGS. 3-5 illustrate exemplary views of the radiating assembly in accordance with an example embodiment of the present disclosure, wherein in FIG. 3 a first conductive member of the radiating assembly is illustrated in solid lines and a second conductive member of the radiating assembly is illustrated in broken lines, in FIG. 4 only the first conductive member of the radiating assembly is illustrated, and in FIG. 5 only the second conductive member of the radiating assembly is illustrated;

FIGS. 6-8 illustrate exemplary views of the radiating assembly in accordance with another example embodiment of the present disclosure, wherein in FIG. 6 a first conductive member of the radiating assembly is illustrated in solid lines and a second conductive member of the radiating assembly is illustrated in broken lines, in FIG. 7 only the first conductive member of the radiating assembly is illustrated, and in FIG. 8 only the second conductive member of the radiating assembly is illustrated;

FIG. 9 illustrates an exemplary exploded view of the radiating assembly in accordance with an example embodiment of the present disclosure;

FIG. 10 illustrates an exemplary perspective view of a feeding element in accordance with an example embodiment of the present disclosure;

FIG. 11 illustrates S parameter curves of the radiating assembly in accordance with an example embodiment of the present disclosure; and

FIG. 12 illustrates a simplified block diagram of an apparatus that is suitable for implementing example embodiments of the present disclosure.

Throughout the drawings, the same or similar reference numerals represent the same or similar element.

### DETAILED DESCRIPTION

Principles of the present disclosure will now be described with reference to some example embodiments. It is to be understood that these embodiments are described only for the purpose of illustration and to help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skill in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to apply such feature, structure, or characteristic in connection with other embodiments whether or not explicitly described.

It should be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of only a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in a server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future types of communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but is not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

In communication networks where a number of network devices are jointly deployed in a geographical area to serve respective cells, a terminal device may have an active connection with a network device when it is located within the corresponding cell. In the active connection, the terminal device may communicate with that network device on the frequency band in both an uplink (UL) and a downlink (DL). The terminal device may need to switch a link in one direction such as the UL to another network device due to various reasons such as quality degradation in the UL.

Conventionally, some approaches have been proposed to realize the dual bands on antenna. For example, two types of dipoles are applied to cover each frequency band respectively. However, such a solution requires much more space and the reduction of the coupling is quite limited. In another known approach, in order to broaden the bandwidth of the dipoles, a parasitic component is added on the antenna. However, the incorporation of the parasitic component increases the structural complexity of the antenna and its scope of usage is limited.

The inventors realize that the formation of a higher frequency band in an antenna may be achieved by the reduction of the resonance size and a formation of a zero electric field may reduce the resonance size of the antenna. In this way, a higher frequency can be generated by means of forming a zero electric field on the antenna.

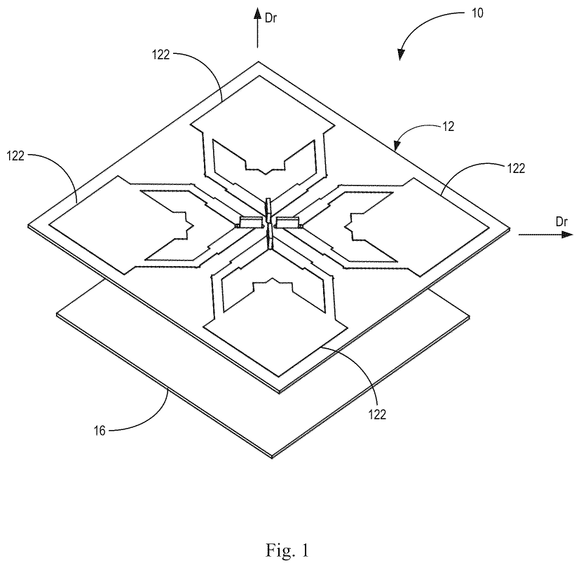

Example embodiments will be described in more detail hereinafter with reference to FIGS. 1-12.

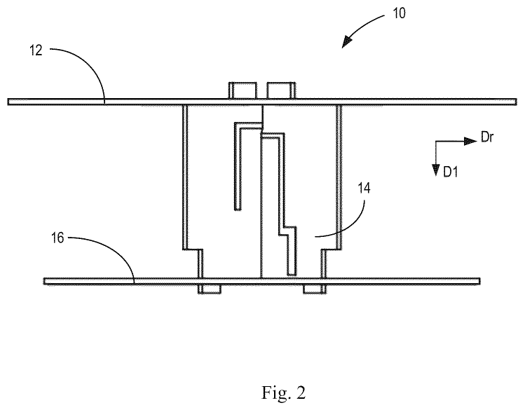

FIGS. 1 and 2 illustrate a perspective view and a front view of a radiating unit 10 in accordance with an example embodiment of the present disclosure, respectively. As illustrated, the radiating unit 10 generally includes, from top to bottom, a radiating assembly 12, a feeding element 14 and a base element 16. The radiating assembly 12 is used to radiate electromagnetic power in a radiating direction Dr.

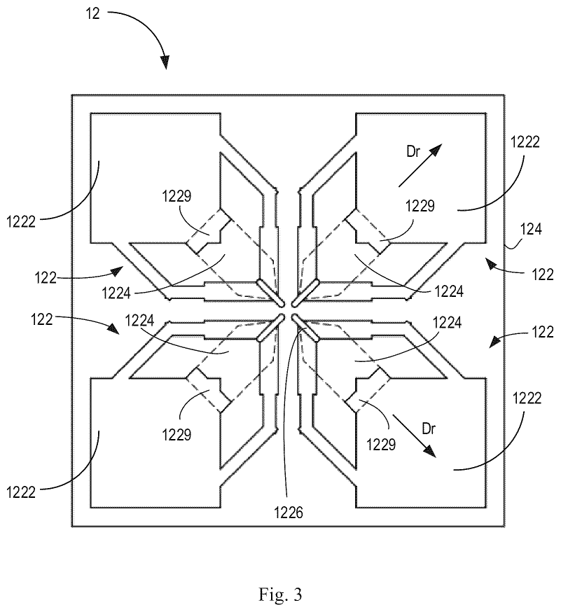

FIGS. 3-5 illustrate different views of the radiating assembly 12 in accordance with an example embodiment of the present disclosure. The radiating assembly 12 generally includes one or more first conductive members 122, second conductive member 1227 and one or more connecting components. The first conductive member 122 is provided on a first layer 1222 may be used to facilitate the radiation of the electromagnetic power in the radiating direction Dr. The second conductive member 1227 is provided on a second layer 1224 which is spaced apart from the first layer 1222 in a first direction D1 normal to the radiating direction Dr. The connecting component 1226 is galvanically connected to both the first conductive member 122 and the second conductive member 1227. The first conductive member 122 and the second conductive member 1227 are at least partially overlapped when being viewed along the first direction D1, such that the first conductive member 122 is further electromagnetically coupled to the second conductive member 1227. This can be best seen in FIG. 3 in which the overlapped area is indicated by 1229.

According to example embodiments of the present disclosure, owing to the presence of the overlapped area 1229, the interaction between the first conductive member 122 and the second conductive member 1227 exerts an area of zero electric field adjacent to the overlapped area 1229. With this arrangement, a resonance size of the radiating assembly 12 can be reduced and a higher frequency band can be generated accordingly. In this way, an antenna with dual frequency bands can be provided.

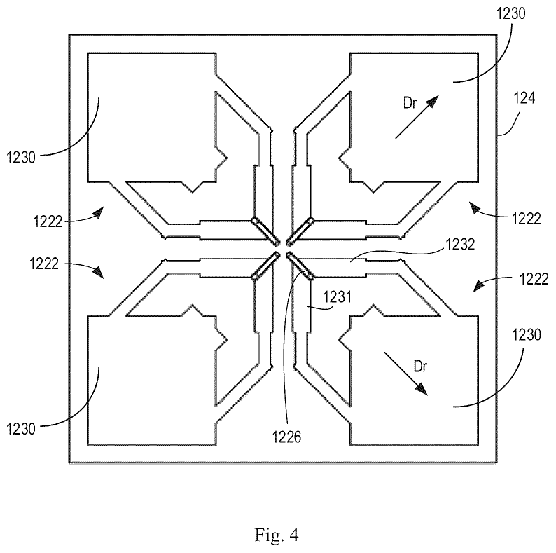

As illustrated in FIG. 4, in some example embodiments, the first conductive member 122 includes a main part 1230 arranged at a distance from the connecting component 1226 along the radiating direction Dr. The first conductive member 122 further includes a first strip 1231 and a second strip 1232 extending from the main part 1230, respectively. As illustrated, the first strip 1231 and the second strip 1232 intersect with each other at the connecting component 1226. In this manner, a complete circuit loop can be formed by means of the first strip 1231, the main part 1230, the second strip 1232, the connecting component 1226 and the second conductive member 1227. Accordingly, an electrical current at a radio frequency (RF) in the circuit loop may be distributed more uniformly, which improves the electromagnetic performance of the radiating assembly 12.

In the illustrated embodiments, the first strip 1231 and the second strip 1232 may be symmetric with respect to the radiating direction Dr. In this way, the manufacturing process of the first conductive member 122 can be simplified. Moreover, the uniformity of current distribution can be improved. It is to be understood that in other embodiments, the first strip 1231 and the second strip 1232 may be arranged in other manners.

Referring back to FIG. 3, in some example embodiments, the main part 1230 and the second conductive member 1227 are at least partially overlapped with each other when being viewed along the first direction D1. In other words, the overlapped area 1229 is formed between the second conductive member 1227 and a part of the main part 1230.

In some example embodiments, as illustrated in FIG. 4, the main part 1230 may be of a rectangular shape. In some example embodiments, the main part 1230 may be of a square shape having four equal lengths. In further example embodiments, the length of the square may be about 21 mm. It is to be understood that the value listed herein is merely illustrative, rather than restrictive.

It is to be understood that in other embodiments, the main part 1230 may be of other shapes, for example an oval, a circle, a polygon including hexagonal, octagonal, etc. In other example embodiments, the main part 1230 may be rounded. The specific shape of the main part 1230 is not limited in this regard.

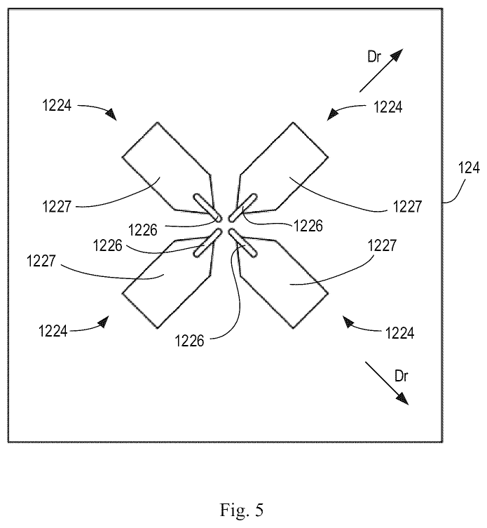

With reference to FIG. 5, the second conductive member 1227 on the second layer 1224 is illustrated to extend from the connecting component 1226 along the radiating direction Dr. With this embodiment, the second conductive member 1227 can be made in a simple and reliable manner. In the shown embodiments, the second conductive member 1227 may be a plate with an elongated shape. As clearly illustrated in FIG. 5, a length L of the second conductive member 1227 along the radiating direction Dr is greater than a width W of the second conductive member 1227 normal to the radiating direction Dr. In some example embodiments, the length L of the second conductive member 1227 may have a value of about 17 mm. In some example embodiments, the width W of the second conductive member 1227 may have a value of about 8 mm. It is to be understood that the values listed herein are merely illustrative, rather than restrictive.

It is to be understood the specific form of the conductive member 1227 is not limited to the plate. For example, the conductive member 1227 can be made by means of a metal stamped part, a sheet metal, conductive ink, laser direct structuring (LDS), molded interconnect devices (MID), and so on.

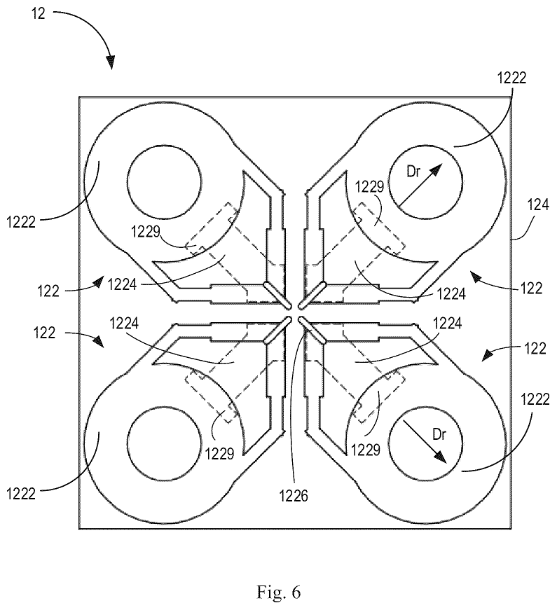

FIGS. 6-8 illustrate different views of the radiating assembly 12 in accordance with another example embodiment of the present disclosure. The radiating assembly 12 as illustrated in FIGS. 6-8 is generally the same as the radiating assembly as described with reference to FIGS. 3-5. The descriptions of identical elements are omitted for brevity and the difference between them will be described in detail hereinafter.

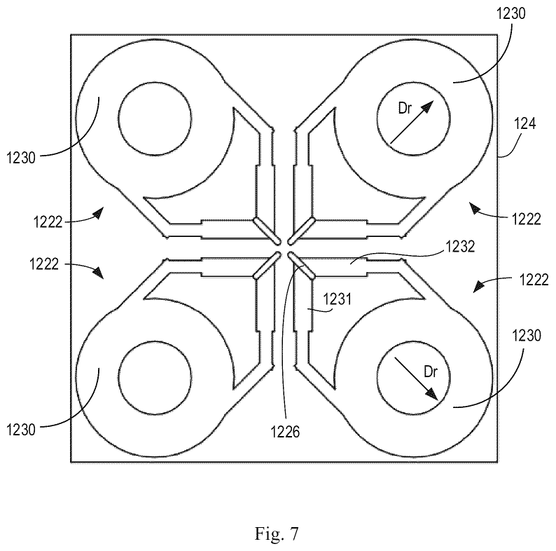

In some example embodiments, as illustrated in FIGS. 6-7, the main part 1230 is of an annular shape. In other example embodiments, the main part 1230 may be a circular shape. The specific shape of the main part 1230 may be determined according to actual implementations and the scope of the present disclosure is not limited in this regard, as long as a complete electrical loop can be formed on the radiating assembly 12. The main part 1230 in other shapes may have a comparable area of the main part 1230 in square shape described above.

In some example embodiments, the maximum length of the first conductive member 122 (i.e., the span of the first conductive member 122 in the radiating direction Dr) may be about 90 mm. It is to be understood that the value listed herein is merely illustrative, rather than restrictive.

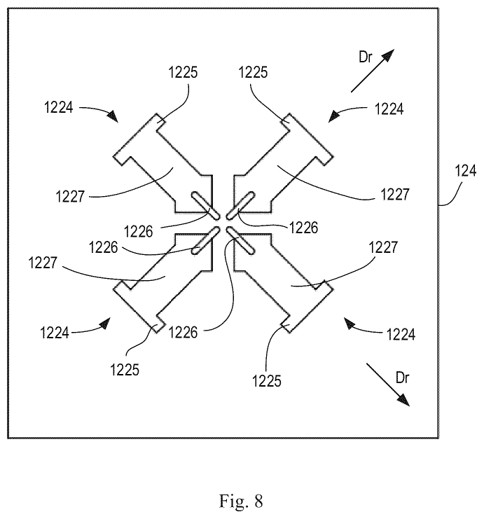

In some example embodiments, as illustrated in FIGS. 6 and 8, the radiating assembly 12 may further include a tail portion 1225 located at an end of the second conductive member 1227 away from the connecting component 1226. As clearly illustrated in FIG. 8, a length L of the second conductive member 1227 along the radiating direction Dr is greater than a width W of the second conductive member 1227 normal to the radiating direction Dr. The tail portion 1225 may extend substantially orthogonal relative to the lengthwise direction of the second conductive member 1227. As illustrated, the length L of the second conductive member 1227 extends from the connecting component 1226 towards the tail portion 1225. With reference to FIG. 6, the provision of the tail portion 1225 allows the main part 1230 and the second conductive member 1227 to be at least partially overlapped with each other when being viewed along the first direction D1.

In some example embodiments, the radiating assembly 12 includes an even number of first conductive members 122, second conductive members 1227 and connecting components 1226 arranged in pairs. Each pair of first conductive members 122, second conductive members 1227 and connecting components 1226 extend in the radiating direction Dr, thus facilitating the radiation of the electromagnetic power in the radiating direction Dr.

In further example embodiments, the plurality of first conductive members 122, second conductive members 1227 and connecting components 1226 may be arranged equiangularly at a same height. The number of the first conductive members 122, second conductive members 1227 and connecting components 1226 may be set according to the different industrial requirements of the communications equipment in which the first conductive members 122 are deployed. As an example, as illustrated in FIGS. 3 and 6, four first conductive members 122, four second conductive members 1227 and four connecting components 1226 are included and they are spaced by substantially 90 degrees. Accordingly, the four first conductive members 122 as shown in FIGS. 4 and 7 are spaced by substantially 90 degrees and the four second conductive members 1227 as shown in FIGS. 5 and 8 are spaced by substantially 90 degrees. It is to be understood that the value listed here is merely illustrative, and the first conductive members 122 and second conductive members 1227 may be spaced by other degrees. The scope of the present disclosure is not limited in this regard.

It is to be understood that even though the plurality of first conductive members 122, second conductive members 1227 and connecting components 1226 are illustrated to be the same, this is only for illustration without suggesting any limitations as to the scope of the subject matter described here. In other embodiments, the first conductive members 122, second conductive members 1227 and connecting components 1226 may be different from each other in some aspects, for example, the size of the first conductive members 122, second conductive members 1227 and connecting components 1226 along the radiating direction Dr.

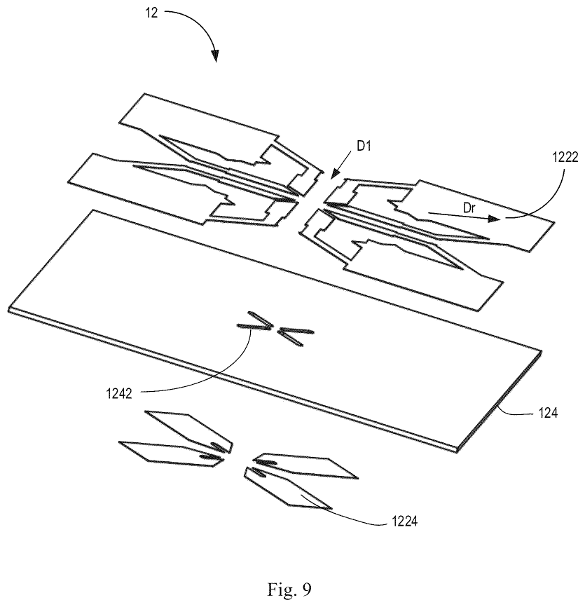

FIG. 9 illustrates an exemplary exploded view of the radiating assembly 12 in accordance with an example embodiment of the present disclosure. In the illustrated embodiments, the radiating assembly 12 further includes a dielectric support 124 arranged between the first conductive members 122 and the second conductive members 1227. The dielectric support 124 may be configured to support the first conductive members 122. The first conductive members 122 are disposed on the top side of the dielectric support 124 and the second conductive members 1227 are disposed on the bottom side of the dielectric support 124. The incorporation of the dielectric support 124 provides a fixed and set physical distance between the first conductive members 122 and the second conductive members 1227 and effectively separates the first conductive members 122 from the second conductive members 1227, which improves the electromagnetic performance of the radiating assembly 12.

As shown in FIG. 9, the dielectric support 124 includes four holes 1242. The connecting component 1226 is allowed to pass through the holes 1242. It is to be understood that the number of the holes 1242 corresponds to the number of the first conductive members 122 included in the radiating assembly 12.

In some example embodiments, the dielectric support 124 is of a rectangular shape, and the holes 1242 are located near a center of the dielectric support 124. In further example embodiments, the dielectric support 124 is of a square shape. The length of the square may be about 70 mm. It is to be understood that the value listed herein is merely illustrative, rather than restrictive.

In some example embodiments, the first conductive members 122, the second conductive members 1227 and the connecting components 1226 may be integrally formed. In this way, they may be manufactured in a fast and convenient manner.

In some example embodiments, the first conductive members 122, the second conductive members 1227 and the connecting components 1226 are made of an electrical conductor. The material of the members may be copper or aluminum. Here are just a few examples, and the specific materials are not limited to embodiments of the present disclosure.

In another aspect, there is provided a radiating unit 10. Referring back to FIG. 2, the feeding element 14 is configured to support the radiating assembly 12 and may be electrically coupled to the radiating assembly 12. The base element 16 may be configured to support the feeding element 14 and provide ground for the first conductive member 122, the second conductive member 1227 via the feeding element 14 and the connecting component 1226.

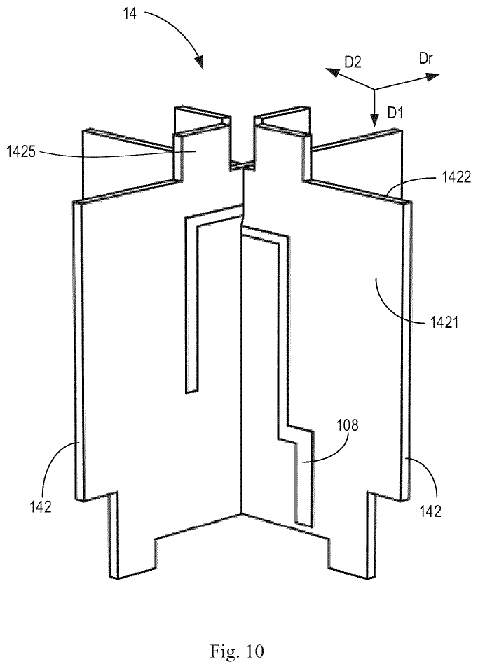

FIG. 10 illustrates an exemplary perspective view of the feeding element 14 in accordance with an example embodiment of the present disclosure. In the illustrated embodiment, the feeding element 14 includes a substrate 142 coupled to the radiating assembly 12. The number of the substrate 142 may correspond to a half of the number of the first conductive members 122. For example, in the case that four first conductive members 122 are provided, two substrates 142 may be provided to couple to the radiating assembly 12.

In some example embodiments, the radiating assembly 12 maybe a printed circuit board (PCB) or alternatively a printed wiring board (PWB).

As can be seen from FIG. 10, the substrate 142 includes a first surface 1421 and a second surface 1422 opposite to the first surface 1421 along a second direction D2. The second direction D2 is perpendicular to the radiating direction Dr and the first direction D1. The substrate 142 includes a protrusion 1425 protruding upwardly from its top. The protrusion 1425 may act as the connecting component 1226 to connect the first conductive member 122 and the second conductive member 1227 as described above. With reference to FIG. 10, there are two protrusions 1425 on each substrate 142 and the feeding element 14 as illustrated totally includes four protrusions 1425. Each protrusion 1425 acts as the respective connecting component 1226. In this way, no extra connecting component 1226 is required, and the radiating unit 10 may be provided in a robust manner.

In some example embodiments, the feeding element 14 may further include a feeding strip 108 arranged on the first surface 1421 and/or the second surface 1422. The feeding strip 108 is adapted to transmit power from a power source (not shown) to the radiating assembly 12. In other example embodiments, the feeding strip 108 may also be adapted to receive power from a power source (not shown) via the radiating assembly 12.

In a further aspect, there is provided an antenna. The antenna includes a radiating assembly 12 and/or a radiating unit 10 described above.

In a further aspect, there is provided an antenna mast. The antenna mast comprises a radiating assembly 12 and/or a radiating unit 10 described above.

In a further aspect, there is provided a base station. The base station comprises an antenna and/or an antenna mast described above.

With the radiating unit 10 in accordance with the present disclosure, the interaction of the first conductive member 122 and the second conductive member 1227 allows a zero electrical field to be formed on the radiating assembly 12 to reduce the resonance size of the radiating assembly 12. Compared with the conventional methods, the antenna including the radiating unit 10 according to example embodiments of the present disclosure allows the formation of a higher frequency band and can be made in a compact manner.

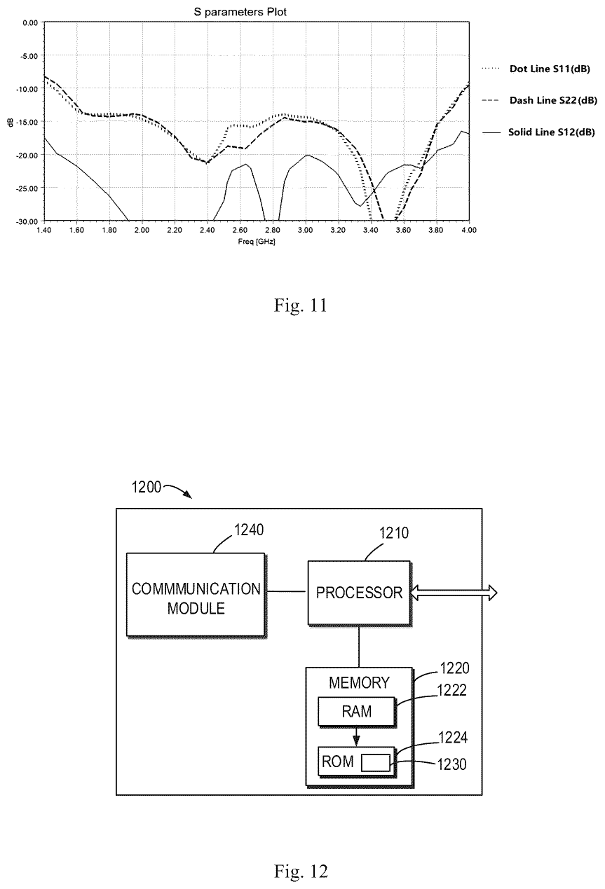

FIG. 11 illustrates S parameter curves of the radiating assembly 12 in accordance with an example embodiment of the present disclosure. In the figure, the dot line represents S11 of the antenna in accordance with an example embodiment of the present disclosure, the dash line S22 of the antenna in accordance with an example embodiment of the present disclosure and the solid line S12 of the antenna in accordance with an example embodiment of the present disclosure. It can be seen from FIG. 11 that S11 and S22 are substantially below −14 dB, which indicates good performance of the radiating assembly 12.

With radiating unit 10 in accordance with the present disclosure, two ranges of resonance frequencies can be obtained. For example, the resonance frequencies of about 1690-2690 MHz and 3.3-3.8 GHz can be obtained. It is to be understood that the values listed herein is merely illustrative, rather than restrictive. Other ranges of resonance frequencies can be acquired depending on the different scenarios wherein different dimensions of the components can be adopted.

FIG. 12 is a simplified block diagram of a device 1200 that is suitable for implementing example embodiments of the present disclosure. As shown, the device 1200 includes one or more processors 1210, one or more memories 1220 coupled to the processor 1210, and one or more communication modules 1240 coupled to the processor 1210.

The communication module 1240 may include the antenna as describe above. The communication module 1240 is for bidirectional communications. The communication module 1240 has at least one antenna to facilitate communication. The communication interface may represent any interface that is necessary for communication with other network elements.

The processor 1210 may be of any type suitable to the local technical network and may include one or more of the following: general purpose computers, special purpose computers, microprocessors, digital signal processors (DSPs) and processors based on multicore processor architecture, as non-limiting examples. The device 1200 may have multiple processors, such as an application specific integrated circuit chip that is slaved in time to a clock which synchronizes the main processor.

The memory 1220 may include one or more non-volatile memories and one or more volatile memories. Examples of the non-volatile memories include, but are not limited to, a Read Only Memory (ROM) 1224, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 1222 and other volatile memories that will not last in the power-down duration.

A computer program 1230 includes computer executable instructions that are executed by the associated processor 1210. The program 1230 may be stored in the memory, e.g., ROM 1224. The processor 1210 may perform any suitable actions and processing by loading the program 1230 into the RAM 1222.

Example embodiments of the present disclosure may also be implemented by hardware or by a combination of software and hardware.

In some example embodiments, the program 1230 may be tangibly stored on a computer readable medium which may be included in the device 1200 (such as in the memory 1220) or other storage devices that are accessible by the device 1200. The device 1200 may load the program 1230 from the computer readable medium to the RAM 1222 for execution. The computer readable medium may include any type of tangible non-volatile storage, such as ROM, EPROM, a flash memory, a hard disk, CD, DVD, and the like.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but is not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1. A radiating assembly for use in a radiating unit, comprising:
a first conductive member provided on a first layer and configured to radiate electromagnetic power in a radiating direction;
a second conductive member provided on a second layer, the second layer spaced apart from the first layer in a first direction perpendicular to the radiating direction; and
a connecting component configured to galvanically connect to the first conductive member and the second conductive member, wherein the first conductive member and the second conductive member are at least partially overlapped when being viewed along the first direction.

2. The radiating assembly of claim 1, wherein the first conductive member comprises:
a main part arranged at a distance from the connecting component along the radiating direction; and
a first strip and a second strip extending from the main part respectively and intersecting with each other at the connecting component, the first strip and the second strip being symmetric with respect to the radiating direction.

3. The radiating assembly of claim 2, wherein the main part and the second conductive member are at least partially overlapped when being viewed along the first direction.

4. The radiating assembly of claim 2, wherein the main part is of a rectangular shape or an annular shape.

5. The radiating assembly of claim 1, wherein the second conductive member extends from the connecting component along the radiating direction.

6. The radiating assembly of claim 5, wherein a length of the second conductive member along the radiating direction is greater than a width of the second conductive member normal to the radiating direction, and
wherein the radiating assembly further comprises a tail portion located at an end of the second conductive member away from the connecting component and extending normal to the radiating direction and perpendicular to the second conductive member.

7. The radiating assembly of claim 1, wherein the radiating assembly comprises an even number of first conductive members, second conductive members and connecting components arranged equiangularly at a same height.

8. The radiating assembly of claim 7, wherein the radiating assembly comprises four first conductive members, four second conductive members and four connecting components spaced by substantially 90 degrees.

9. The radiating assembly of claim 1, further comprising:
a dielectric support arranged between the first conductive member and the second conductive member and configured to support the first conductive member, wherein the dielectric support comprises a hole provided for the connecting component to pass therethrough.

10. The radiating assembly of claim 9, wherein the dielectric support is of a rectangular shape, and wherein the hole is located adjacent to a center of the dielectric support.

11. The radiating assembly of claim 1, wherein the first conductive member, the second conductive member and the connecting component are integrally formed.

12. The radiating assembly of claim 1, wherein the first conductive member, the second conductive member and the connecting component are made of an electrical conductor including copper or aluminum.

13. A radiating unit comprising:
the radiating assembly of claim 1;
a feeding element configured to support the radiating assembly and electrically coupled to the first conductive member; and
a base element configured to support the feeding element and provide ground for the radiating assembly via the feeding element.

14. The radiating unit of claim 13, wherein the feeding element comprises:
a substrate coupled to the first conductive member, the substrate having a first surface and a second surface opposite to the first surface along a second direction perpendicular to the radiating direction and the first direction; and
a protrusion protruding upwardly from a top of the substrate as the connecting component.

15. The radiating unit of claim 14, wherein the feeding element further comprises a feeding strip arranged on the first surface and/or the second surface and adapted to transmit power from a power source to the radiating assembly.

16. An antenna comprising the radiating assembly of claim 1.

17. An antenna mast comprising the radiating assembly of claim 1.

18. A base station comprising the antenna of claim 16.
